(19) United States
(12) Patent Application Publication
(10) Pub. No.: US 2024/0402833 A1
(43) Pub. Date: Dec. 5, 2024

(54) INPUT DEVICE INCLUDING CONTAINER WITH DEFORMABLE PORTION

(71) Applicant: Makoto SHIDA, Tokyo (JP)

(72) Inventor: Makoto SHIDA, Tokyo (JP)

(73) Assignee: MITSUMI ELECTRIC CO., LTD., Tokyo (JP)

(21) Appl. No.: 18/660,690

(22) Filed: May 10, 2024

(30) Foreign Application Priority Data
May 29, 2023 (JP) 2023-087506
Jun. 26, 2023 (JP) 2023-104217

(51) Int. Cl. G06F 3/03

(52) U.S. Cl. CPC G06F 3/03

(57) ABSTRACT

An input device includes an input mechanism, a sensor, and a mounting structure. The input mechanism includes a container. The container includes a tactile portion and a transmission portion. The tactile portion and the transmission portion are deformable. The container is capable of encasing a fluid. The sensor is configured to detect a force applied to the transmission portion. The sensor is disposed on the mounting structure.

### CROSS-REFERENCE TO RELATED APPLICATIONS

This application claims priority under 35 U.S.C. § 119 to Japanese Patent Application No. 2023-087506, filed May 29, 2023, and Japanese Patent Application No. 2023-104217, filed Jun. 26, 2023, the contents of which are incorporated herein by reference in their entirety.

### BACKGROUND

### 1. Field of the Invention

The present disclosure relates to input devices.

### 2. Description of the Related Art

For example, input devices, which can detect input operations of a user, include sensors capable of detecting forces applied by the input operations (see, for example, Japanese Unexamined Patent Application Publication Nos. 2018-185296 and 2013-080325).

There are input devices in which a force applied by an input operation is transmitted via a fluid (see, for example, Japanese Unexamined Patent Application Publication No. 2013-080325). In recent years, operations are becoming more and more complex. Therefore, there is a need for an input device that can detect a directional force in a plurality of directions via a fluid.

### SUMMARY

One aspect of embodiments of the present disclosure aims to provide an input device capable of transmitting a force applied in a plurality of directions based on an input operation via a fluid. Moreover, one aspect of embodiments of the present disclosure aims to provide an input device capable of transmitting a force applied in a plurality of directions based on an input operation via members.

According to one aspect of the present disclosure, an input device includes an input mechanism, a sensor, and a mounting structure. The input mechanism includes a container. The container includes a deformable tactile portion and a deformable transmission portion. The container is capable of encasing a fluid. The sensor is configured to detect a force applied to the transmission portion. The sensor is disposed on the mounting structure.

The object and advantages of the embodiments will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF THE DRAWINGS

FIG. 1 is a perspective view illustrating an example of the input device of a first embodiment;

FIG. 2 is a cross-sectional view illustrating an example of the input device of the first embodiment;

FIG. 3 is a cross-sectional enlarged view illustrating an example of a sensor and a sensor housing;

FIG. 4 is a diagram illustrating an example of directions of a force Fx in an X axis, a force Fy in a Y axis, a force Fz in a Z axis, a moment Mx of force rotating around the X axis, a moment My of force rotating around the Y axis, and a moment Mz of force rotating around the Z axis;

FIG. 5 is a plan view of the sensor, illustrating an example of a region to which a force is applied from the transmission portion;

FIG. 6 is a plan view of the sensor, illustrating an example of a region to which a force is applied from the transmission portion;

FIG. 7 is a plan view of the sensor, illustrating an example of a region to which a force is applied from the transmission portion;

FIG. 8 is a cross-sectional view illustrating an example of an input mechanism of the input device of a second embodiment;

FIG. 9 is a cross-sectional view illustrating an example of the input mechanism of the input device of a third embodiment;

FIG. 10 is a perspective view illustrating an example of a force sensor device of a fourth embodiment;

FIG. 11 is a perspective view illustrating an example of a sensor chip, a flexible substrate, and an elastic element;

FIG. 12 is a cross-sectional perspective view illustrating an example of an elastic element of the force sensor device;

FIG. 13 is a cross-sectional view illustrating a modification example of the sensor and the sensor housing;

FIG. 14 is a cross-sectional view illustrating an example of the input mechanism of the input device of a fifth embodiment;

FIG. 15 is a view illustrating an example of the input device of the fifth embodiment, when a force is applied to the tactile portion of the input device;

FIG. 16 is a view illustrating another example of the input device of the fifth embodiment, when a force is applied to the tactile portion of the input device; and

FIG. 17 is a view illustrating yet another example of the input device of the fifth embodiment, when a force is applied to the tactile portion of the input device.

### DESCRIPTION OF THE EMBODIMENTS

One or more embodiments of the present disclosure will be described in detail with reference to the drawings. In the drawings, the same components are denoted by the same numerals, and redundant description thereof may be omitted as appropriate.

### [Input Device of First Embodiment]

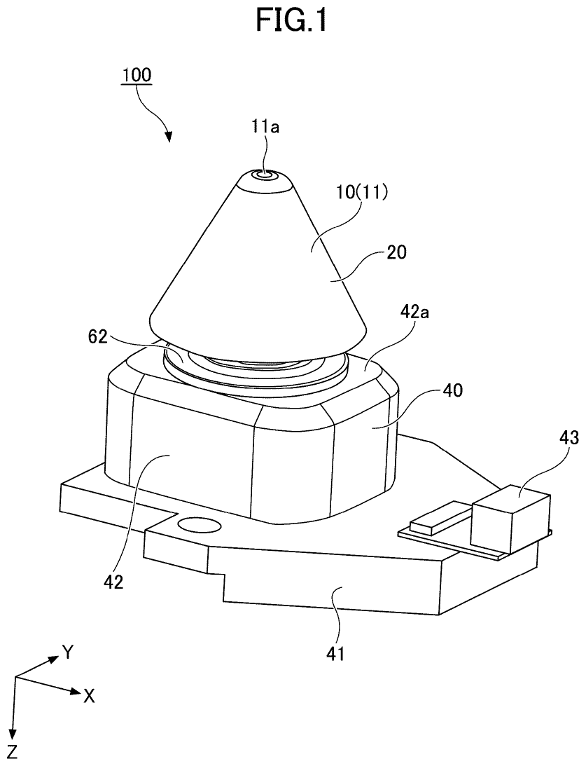

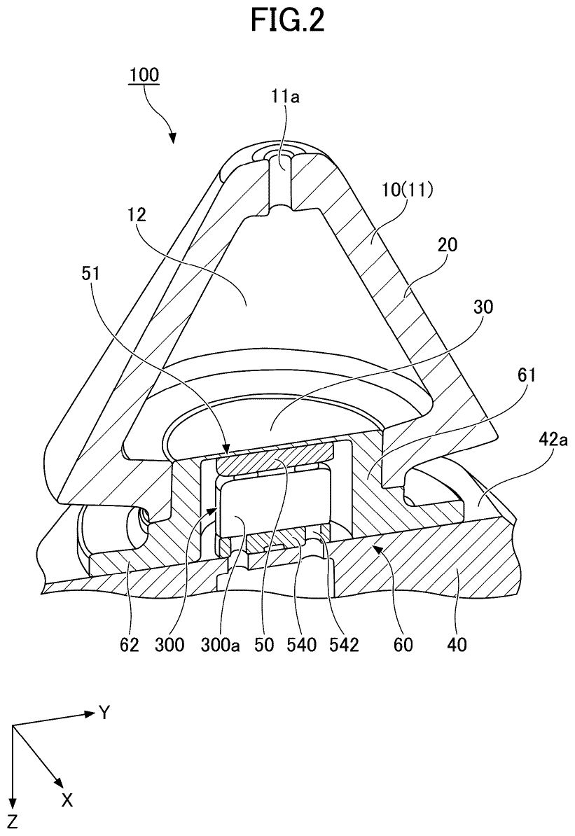

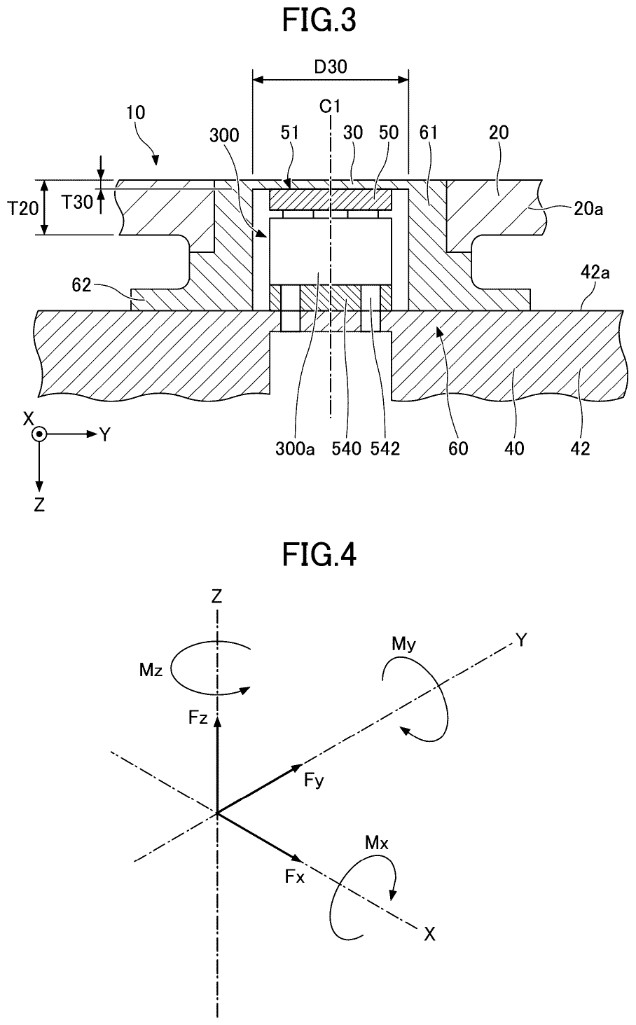

An input device 100 of a first embodiment will be described with reference to FIGS. 1 to 8. FIG. 1 is a perspective view illustrating an example of the input device 100 of the first embodiment. FIG. 2 is a cross-sectional view illustrating an example of the input device 100 of the first embodiment. FIG. 3 is a cross-sectional enlarged view illustrating a sensor 300 and a sensor housing 60. For reference, an X axis, a Y axis, and a Z axis, which are perpendicular to one another, are depicted in each of FIGS. 1 to 3. The X axis, Y axis, and Z axis may be depicted in other figures, as appropriate. The X axis, Y axis, and Z axis may not necessarily be perpendicular to one another. An XY plane is a plane extending along the X axis and the Y axis. An XZ plane is a plane extending along the X axis and the Z axis. A YZ plane is a plane extending along the Y axis and the Z axis.

As illustrated in FIGS. 1 and 2, the input device 100 includes an input mechanism 10 including a container 11 and a mounting structure 40. The container 11 is capable of encasing a fluid. As illustrated in FIG. 2, the input device 100 includes a sensor 300. For example, the input device 100 is a device capable of performing input operations to electronic devices. The input device 100 can be used as a device for inputting instructions to other machines and devices.

### [Input Mechanism]

The input mechanism 10 is an input mechanism that can be operated by a user.

### [Container 11]

The container 11 is a container capable of encasing a fluid. Examples of the fluid include a liquid and a gas. The fluid may be a gel. The container 11 includes a tactile portion 20 and a transmission portion 30. A hollowed-out space 12 is formed inside the container 11. The hollowed-out space 12 is a space partitioned off by the tactile portion 20 and the transmission portion 30. For example, the container 11 has a conical shape. The container 11 includes a conical portion and a bottom portion. Moreover, an orifice 11a is formed in the container 11. A fluid is fed into and discharged from the hollowed-out space 12 through the orifice 11a. For example, the orifice 11a is sealed with a sealing material. For example, the orifice 11a is arranged at an apex of the conical portion of the container 11. The container 11 may be, for example, in a shape of a cylinder, a sphere, or a cuboid.

### [Tactile Portion]

The tactile portion 20 constitutes part of the container 11. The tactile portion 20 is partially deformable. A whole part of the tactile portion 20 may be deformable. The tactile portion 20 constitutes the conical portion of the container 11. A fluid is disposed in a space inside the tactile portion 20. The tactile portion 20 is not particularly limited, except that the tactile portion is deformable and constitutes part of the container 11. For example, the tactile portion 20 is formed of silicone. For example, the tactile portion may be formed of rubber.

The tactile portion 20 may include part of the bottom portion of the container 11. In the present embodiment, the tactile portion 20 includes an outer circumference of the bottom portion of the container 11. The tactile portion 20 includes a portion that is operated by a user. A user can pinch, press, push, pull, bend, or twist the tactile portion 20 to perform input operations.

### [Transmission Portion]

As illustrated in FIGS. 2 and 3, the transmission portion 30 constitutes part of the bottom portion of the container 11. At least part of the transmission portion 30 is deformable. A whole part of the transmission portion 30 may be deformable. For example, the transmission portion 30 has a disc shape. A thickness direction of the transmission portion 30 is the Z-axis direction. The transmission portion 30 is joined to the tactile portion 20 to form the hollowed-out space 12 inside the container 11. A portion 20a having an opening is arranged in the bottom portion of the tactile portion 20. The transmission portion 30 is disposed in the opening of the portion 20a. A force input to the tactile portion 20 is transmitted to the transmission portion via the fluid inside the hollowed-out space 12.

### [Sensor]

The sensor 300 is configured to detect the force applied to the transmission portion 30. For example, the sensor 300 is a force sensor. The force sensor will be described below in detail. The sensor 300 is not limited to a force sensor. For example, the sensor 300 may be a capacitive sensor, a strain gauge, an optical sensor, or a magnetic sensor. For example, the sensor 300 includes a sensor main body 300a including a sensor chip.

### [Detector]

The sensor 300 includes a detector 50. The force applied to the transmission portion 30 is transmitted to the detector 50. The detector 50 is configured to be in contact with the transmission portion 30. The detector 50 is disposed between the sensor main body 300a and the transmission portion 30 in the Z-axis direction. For example, the detector 50 has a disc shape. A thickness direction of the detector 50 is the Z-axis direction.

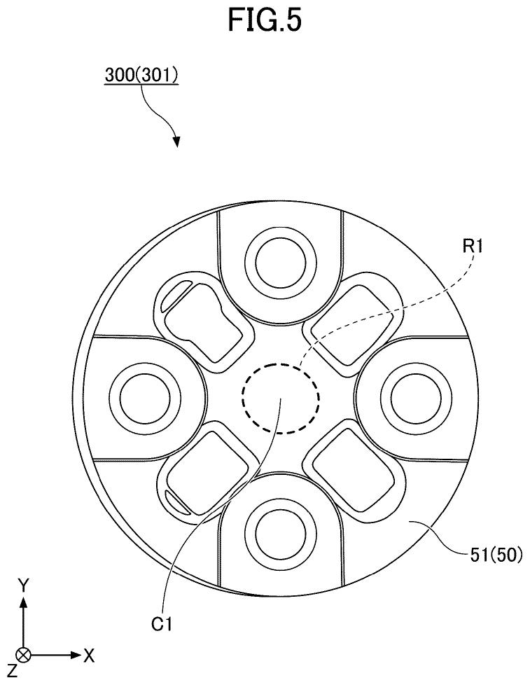

The detector 50 includes a first portion. When a force is not input to the tactile portion 20, the first portion of the detector 50 is in contact with the transmission portion 30. When a force is input to the tactile portion 20, the first portion of the detector 50 is brought into contact with the transmission portion 30 with a stronger pressure compared to when force is not input to the tactile portion 20. The phrase “when a force is not input to the tactile portion 20” encompasses a state where a user is not touching the tactile portion 20. The phrase “when force is input to the tactile portion 20” encompasses a state where a user applies a force to the tactile portion 20. The first portion will be described with reference to FIGS. 5 to 7 in detail.

When a force is input to the tactile portion 20, the transmission portion 30 is pushed out in a direction toward the detector 50. There may be a gap between the transmission portion 30 and the detector 50 in the Z-axis direction. The transmission portion 30 is pushed out in the direction toward the detector 50 to be in contact with the detector 50.

The detector 50 includes a plane 51 that extends in an X-axis direction and a Y-axis direction, where the X-axis direction and the Y-axis direction intersect each other. The plane 51 is one example of a first plane. The X-axis direction is one example of a first direction. The Y-axis direction is one example of a second direction.

The sensor 300 can detect a moment of force rotating around the X axis or Y axis at a position outside a center Cl of the plane 51. The center Cl of the plane 51 may be a center of the detector 50 as viewed in the Z-axis direction.

For example, the tactile portion 20 is deformed when the tactile portion 20 is pushed down in the X-axis direction or Y-axis direction in a state in which the force is input by pinching the tactile portion 20. As the deformation occurs, the transmission portion 30 is deformed to be pushed out toward the detector 50 in the Z-axis direction via the fluid. As a result, the first portion is brought into contact with the transmission portion 30 with the stronger pressure so that the sensor 300 detects the force applied to the detector 50.

### [Mounting Structure]

As illustrated in FIGS. 2 and 3, the input device 100 includes the mounting structure 40 on which the sensor 300 is disposed. As illustrated in FIG. 1, the mounting structure 40 includes a base 41, a support table 42, and a terminal 43. For example, the base 41 has a plate shape. The base 41 includes a bottom surface that can be placed on, for example, a desk or the like. The support table 42 is projected from the base 41 in the Z-axis direction. For example, the support table 42 is in a shape of a cuboid. The support table 42 includes a support surface 42a. The input mechanism 10 and the sensor 300 are disposed on the support surface 42a.

The terminal 43 illustrated in FIG. 1 is a data-output terminal. The terminal 43 is disposed on the base 41. The terminal 43 is electrically coupled to the sensor chip of the sensor 300. Wires for electrically coupling the terminal 43 with the sensor chip are formed on the support table 42 and the base 41. The data collected by the sensor 300 is output via the terminal 43.

### [Sensor Housing]

Next, the sensor housing 60 that houses the sensor 300 will be described with reference to FIGS. 2 and 3. The input device 100 includes the sensor housing 60. The sensor housing 60 includes the transmission portion 30 and a cylinder portion 61. An axial direction of the cylinder portion 61 is the Z-axis direction. The cylinder portion 61 is extended from the transmission portion 30 toward the support surface 42a of the mounting structure 40. The transmission portion 30 is disposed at one end of the cylinder portion 61 to close an opening of the cylinder portion 61.

A flange 62 is formed at one end of the cylinder portion 61 adjacent to the mounting structure 40. The flange 62 is projected outward from the cylinder portion 61 in a radial direction of the cylinder portion 61. The flange 62 is disposed on the support surface 42a of the mounting structure 40. The sensor 300 is disposed in a space partitioned off by the transmission portion 30, the cylinder portion 61, and the mounting structure 40.

The sensor 300 is fastened on the support table 42 of the mounting structure 40. The sensor 300 may be screwed onto the support table 42.

### [Rigidity of Tactile Portion and Transmission Portion]

Next, rigidity of the tactile portion 20 and the transmission portion 30 will be described. As illustrated in FIG. 3, a thickness T30 of the transmission portion 30 is preferably smaller than a thickness T20 of the tactile portion 20, when a material of the tactile portion 20 and a material of the transmission portion 30 are identical. According to the configuration described above, the transmission portion 30 can be deformed via the fluid, when a user applies a force to the tactile portion 20.

Moreover, the following relationship of rigidity is satisfied.
(1)>(2)
(1): Rigidity of an entire tactile portion when the force is determined by “pressure generated by pressing x inner surface area of tactile portion”
(2): Rigidity of an entire transmission portion when the force is determined by “pressure generated by pressing x area of transmission portion”

Specifically, if the inner surface area of the tactile portion 20 and the area of the transmission portion 30 are the same, the rigidity of the transmission portion 30 is preferably lower than the rigidity of the tactile portion 20. The transmission portion 30 is more easily deformed compared to the tactile portion 20. According to the configuration described above, the transmission portion 30 can be deformed via the fluid, when a user applies a force to the tactile portion 20.

### [Fluid]

A fluid is encased in the container 11 of the input mechanism 10. The fluid may be a liquid or a gas. For example, the fluid may be water. Moreover, the fluid may be a gel, such as a silicone gel. For example, the gas may be air. For example, the hollowed-out space 12 of the container 11 is charged with a liquid or a gel.

For example, as a user holds the tactile portion 20, the liquid (fluid) inside the container 11 is moved so that the transmission portion 30 pushes the detector 50 with a strong pressure. As described above, the force is transmitted to the detector 50 via the transmission portion 30. Depending on how a user holds the tactile portion 20, the movement of the liquid inside the container 11 changes. The phrase “the liquid moves” or “the movement of the liquid changes” means that an outer shape of the container 11 encasing the liquid changes. The change of the outer shape of the container 11 includes changes of the shapes of the tactile portion 20 and the transmission portion 30. The force applied to the tactile portion 20 by a user is transmitted to the detector 50 via the liquid and the transmission portion 30.

### [Detection by Sensor]

FIG. 4 is a diagram illustrating an example of directions of a force Fx in the X-axis direction, a force Fy in the Y-axis direction, a force Fz in the Z-axis direction, a moment Mx of force rotating around the X axis, a moment My of force rotating around the Y axis, and a moment Mz of force rotating around the Z axis. For example, the sensor 300 can detect the force Fx in the X-axis direction, the force Fy in the Y-axis direction, and the force Fz of the Z-axis direction. The sensor 300 can detect the moment Mx of force rotating around the X axis, the moment My of force rotating around the Y axis, and the moment Mz of force rotating around the Z axis.

In each figure, the X-axis direction, the Y-axis direction, and the Z-axis direction may be depicted as arrows. The X-axis direction, the Y-axis direction, and the Z-axis direction are assigned relative to the sensor 300. When the orientation of the sensor 300 is changed, for example, the orientations of the X-axis direction, the Y-axis direction, and the Z-axis direction are also changed according to the orientation of the sensor 300. The X-axis direction includes both a direction indicated with an arrow and a reverse direction of the direction indicated with the arrow. The Y-axis direction includes both a direction indicated with an arrow and a reverse direction of the direction indicated with the arrow. The Z-axis direction includes both a direction indicated with an arrow and a reverse direction of the direction indicated with the arrow.

Table 1 is a table summarizing a relationship between an operation performed on the tactile portion and detection performed by the sensor. The detection performed by the sensor 300 presented in Table 1 is of typical directions of the force detected by the sensor 300, and the sensor 300 may also detect other forces. In a case where a user pinches the tactile portion 20, the sensor 300 detects a force Fz. The motion of “pinching” causes the force, which is applied to the tactile portion 20, to transmit to the transmission portion 30 via the fluid, thereby pushing the transmission portion against the detector 50. The motion of pinching the tactile portion 20 also includes holding the tactile portion 20. In a case where a user presses the tactile portion 20 in the Z-axis direction, the sensor 300 detects the force Fz. In a case where a user pushes the tactile portion 20 down in the Y-axis direction, the sensor 300 detects the force Fy and the moment Mx. In a case where a user pushes the tactile portion 20 down in the X-axis direction, the sensor 300 detects the force Fx and the moment My. In a case where a user pinches the tactile portion 20 to steer the tactile portion 20 in circular motion around the Z axis as a center, the sensor 300 detects the force Fx, the force Fy, the force Fz, the moment Mx, and the moment My. In a case where a user pinches the tactile portion 20 to twist the tactile portion 20 around the Z axis as a center, the sensor 300 detects the force Fz and the moment Mz. With a maneuver of the tactile portion 20 carried out by a user, an input operation, which is typically performed by pushing a button in the related art, or a directional input operation, which is typically performed by shifting a lever in the related art, can be performed.

TABLE 1

| Operation on tactile portion | Detection by sensor |
|---|---|
| Pinch | Force Fz |
| Press in Z-axis direction | |
| Push down in Y-axis | Force Fy, Moment Mx |
| direction | |
| Push down in X-axis | Force Fx, Moment My |
| direction | |
| Pinch to steer in | Force Fx, Force Fy, Force |
| circular motion around Z | Fz, Moment Mx, Moment |
| axis as a center | My |
| Pinch to twist around Z | Force Fz |
| axis as a center | Moment Mz |

FIGS. 5 to 7 are each a plan view of the sensor 300 illustrating an example of a region to which a force is applied from the transmission portion 30. FIG. 5 illustrates an example of a state of the sensor 300 when a user pinches the tactile portion 20 or presses the tactile portion 20 in the Z-axis direction. In the example illustrated in FIG. 5, for example, the sensor 300 can detect the force Fz. In FIG. 5, the force is applied to a region R1 that is a central region of the detector 50. When a force is input to the tactile portion 20, the region R1 is a region where the transmission portion 30 and the detector 50 comes into contact with each other with a stronger pressure compared to when force is not input to the tactile portion 20. For example, the region R1 has a circular shape. Specifically, the region R1 is an example of the first portion of the detector 50.

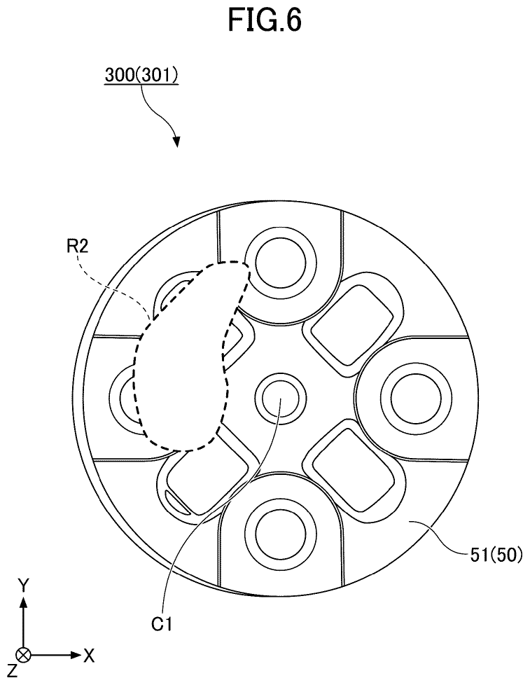

FIG. 6 illustrates an example of a state of the sensor 300 where a user pushes the tactile portion 20 down in a negative direction along the X axis and a positive direction along the Y axis. In FIG. 6, the direction indicated with the arrow is determined as a positive direction, and the reverse direction of the direction indicated with the arrow is determined as a negative direction. In the example illustrated in FIG. 6, for example, the sensor 300 detects the force Fz, moment Mx, and moment My. In FIG. 6, the force is applied to a region R2 that is outside the center of the detector 50. Since the sensor 300 detects the moment Mx and the moment My, approximately how far the position of the applied force is from the center of the detector 50 can be detected. When a force is input to the tactile portion 20, the region R2 is a region where the transmission portion 30 and the detector 50 come into contact with each other with a stronger pressure compared to when force is not input to the tactile portion 20. Depending on a manner of pushing the tactile portion 20 down, the region R2 does not necessarily have a circular shape. For example, the region R2 may have a shape that is irregularly curved along a circumferential direction of the detector 50. Specifically, the region R2 is an example of the first portion of the detector 50.

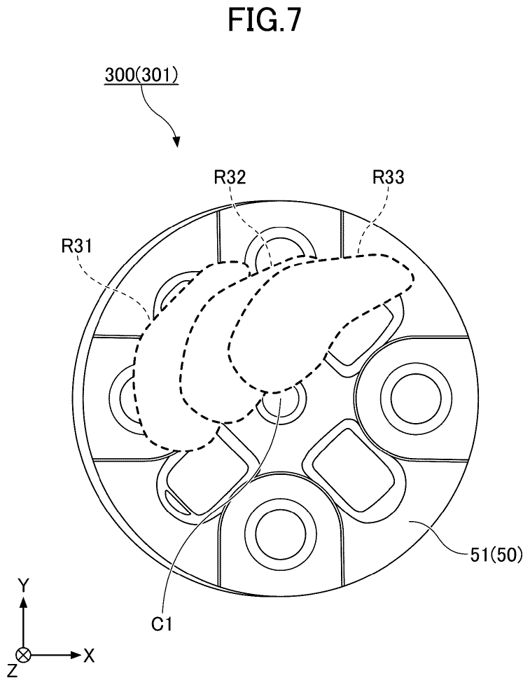

FIG. 7 illustrates an example of a state of the sensor 300 where a user pinches the tactile portion 20 to steer the tactile portion 20 in circular motion around the Z-axis direction as a center. Specifically, it is a state where a user pinches the tactile portion 20 and changes the force continuously applied in the X-axis direction, or the Y-axis direction, or the X-axis direction and the Y-axis direction. In the example illustrated in FIG. 7, for example, the sensor 300 detects the force Fz, the moment Mx, and the moment My. In FIG. 7, the force is applied to regions R31 to R33 that are outside the center of the detector 50. When a force is input to the tactile portion 20, the regions R31 to R33 are regions where the transmission portion 30 and the detector 50 come into contact with each other with a stronger pressure compared to when a force is not input to the tactile portion 20. For example, the regions R31 to R33 each have a shape that is irregularly curved along the circumferential direction of the detector 50. For example, a region to which force is applied is shifted between the region R31, the region R32, and the region R33, in this order. The regions R1, R2, and R31 to R33 are examples of the first portion of the detector 50.

### [Functions and Effects of Input Device of First Embodiment]

The input device 100 of the first embodiment includes the input mechanism 10, the sensor 300, and the mounting structure 40. The input mechanism 10 includes the container 11. The container 11 includes the tactile portion 20 and the transmission portion that are deformable. The container 11 is capable of encasing a fluid. The sensor 300 is configured to detect a force applied to the transmission portion 30. The sensor 300 is disposed on the mounting structure 40. In the input device 100, a force input to the tactile portion 20 by a user through an input operation can be transmitted to the sensor 300 via the fluid inside the container 11.

In the input device 100 of the present embodiment, a force acting in a plurality of directions can be transmitted to the sensor 300 via the fluid retained in the hollowed-out space 12 inside the container 11. In the input device 100, the force applied in a plurality of directions based on complex operations can be transmitted to the sensor 300 via the fluid.

In the input device 100, the sensor 300 includes the detector 50. The detector 50 can be brought into contact with the transmission portion 30. The force applied to the transmission portion 30 is transmitted to the detector 50. When a force is not input to the tactile portion 20, the detector 50 is in contact with the transmission portion 30. When force is input to the tactile portion 20, the detector 50 includes a first portion that is in contact with the transmission portion 30 with a stronger pressure compared to when force is not input to the tactile portion 20. The sensor 300 can detect the force transmitted to the first portion.

In the input device 100, when a force is input to the tactile portion 20, the transmission portion 30 is pushed out toward the detector 50 to create a region where the transmission portion 30 is brought into contact with the detector 50 with a strong pressure. Therefore, the sensor 300 can detect the transmitted force via the detector 50. The phrase “to create a region where the transmission portion 30 is brought into contact with the detector 50 with a strong pressure” means that the transmission portion 30 and the detector 50 are in contact with each other with a strong pressure compared to when force is not input to the tactile portion 20.

In the input device 100, the detector 50 includes a plane (first plane) 51 extending along the X-axis direction (first direction) and the Y-axis direction (second direction) that intersect each other. The sensor 300 can detect a moment of force rotating around the X axis or the Y axis in the region R1 or R2 that is a position outside the center Cl of the plane 51. Since the sensor 300 can detect the moment Mx of force rotating around the X axis, the sensor 300 can detect the force applied in the position outside the center of the plane 51. Since the sensor 300 can detect the moment My of force rotating around the Y axis, the sensor 300 can detect how far the position in which the force is applied is from the center of the plane 51.

In the input device 100, the first portion is deformed when the tactile portion 20 operates to change force continuously applied in the X-axis direction or Y-axis direction in a state where the force is input by pinching the tactile portion 20. The “changing force continuously applied” may include a case where applied force is not constant.

Moreover, the input device 100 includes the sensor housing 60, in which the sensor 300 is housed. The transmission portion 30 constitutes the top surface of the sensor housing 60. The sensor housing 60 includes the cylinder portion 61 extending in a direction intersecting the transmission portion 30. The flange 62 is disposed at the opposite side of the cylinder portion 61 to the transmission portion 30. The flange 62 is coupled to the mounting structure. The sensor 300 is disposed in the space partitioned off by the transmission portion 30, the cylinder portion 61, and the mounting structure 40. In the input device 100, the sensor 300 can be disposed inside the sensor housing 60. The phrase “the transmission portion constituting the top surface” means that the transmission portion is arranged in a manner such that the arranged transmission portion forms the top surface of the sensor housing.

In the input device 100, the thickness T30 of the transmission portion 30 is preferably smaller than the thickness T20 of the tactile portion 20, and the deformation of the transmission portion 30 is greater than the deformation of the tactile portion 20. In the input device 100, the transmission portion 30 is deformed to transmit the force to the sensor 300.

In the input device 100, the rigidity of the transmission portion 30 is lower than the rigidity of the tactile portion 20. In the input device 100, the transmission portion 30 is deformed to transmit the force to the sensor 300.

In the input device 100, the fluid may be a liquid or a gel. In the input device 100, the force can be transmitted to the transmission portion 30 via the liquid or gel inside the container 11. The sensor 300 can detect the force transmitted via the transmission portion 30.

Generally, a gas has higher compressibility than a liquid. Therefore, the input force can be efficiently transmitted to the sensor 300 by using water as the fluid. If a gas is used as the fluid, the input force can be attenuated, and the attenuated force can be transmitted to the sensor 300. Specifically, a desired sense of force can be output to the sensor 300 by selectively using a liquid, a gas, or a gel.

### [Input Device of Second Embodiment]

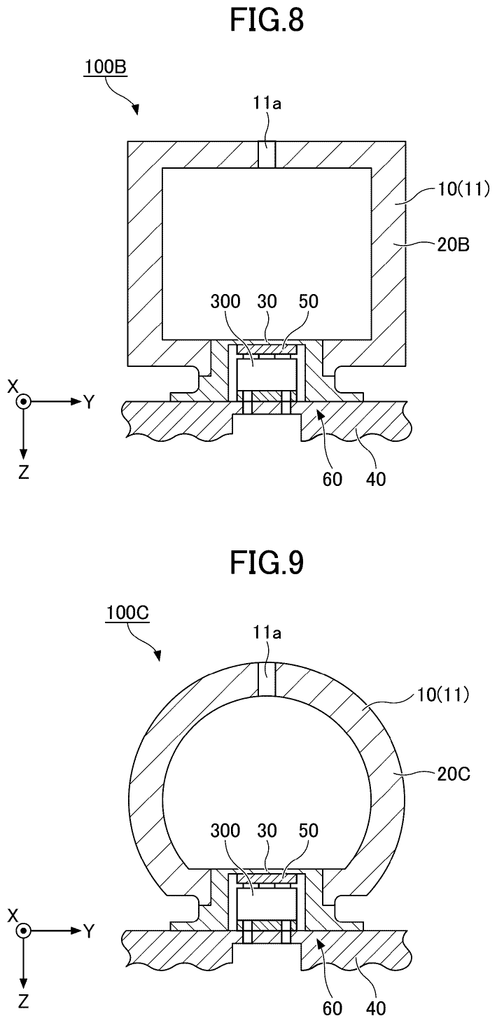

Next, the input device 100B of the second embodiment will be described with reference to FIG. 8. FIG. 8 is a cross-sectional view illustrating an example of the input mechanism 10 of the second embodiment. The input device 100B of the second embodiment illustrated in FIG. 8 is identical to the input device 100 of the first embodiment, except that the input device 100B includes a tactile portion 20B instead of the tactile portion 20. The tactile portion 20B has a different shape to the shape of the tactile portion 20. In the description of the second embodiment, redundant description that may be already mentioned in the first embodiment is omitted.

For example, the tactile portion 20B of the input device 100B has a shape of a column (a cylindrical shape). A space is formed inside the tactile portion 20B, and a fluid is disposed in the space inside the tactile portion 20B.

The input device 100B of the second embodiment also has the functions and effects comparable to the input device 100 of the first embodiment. The tactile portion 20B may be formed into a shape of a column. Moreover, the container 11 of the input mechanism 10 may include a cylinder. The shape of the tactile portion 20B is not limited to the column. For example, the tactile portion 20B may have a shape of a cuboid or a cube, or any other shape.

### [Input Device of Third Embodiment]

Next, an input device 100C of a third embodiment will be described with reference to FIG. 9. FIG. 9 is a cross-sectional view illustrating an example of the input mechanism 10 of the input device 100C of the third embodiment. The input device 100C of the third embodiment illustrated in FIG. 9 is identical to the input device 100 of the first embodiment, except that the input device 100C includes a tactile portion 20C instead of the tactile portion 20. The tactile portion 20C has a different shape to the shape of the tactile portion 20. In the description of the third embodiment, redundant description that may be already mentioned in the first embodiment is omitted.

For example, the tactile portion 20C of the input device 100C has a spherical shape. A space is formed inside the tactile portion 20C, and a fluid is disposed in the space inside the tactile portion 20C. The tactile portion 20C includes a spherical surface.

The input device 100C of the third embodiment also has functions and effects comparable to the input device 100 of the first embodiment. The tactile portion 20C may be formed into a shape of a sphere. The container 11 of the input mechanism 10 may include a sphere. The shape of the tactile portion 20C is not limited to a sphere. For example, the tactile portion 20C may be a semicircular shape, a shape having a curved surface, or any other shape.

### [Force Sensor Device 301 of Fourth Embodiment]

Next, a force sensor device 301 of a fourth embodiment will be described. The force sensor device 301 can be used as the above-described sensor 300. The force sensor device 301 of the present embodiment can detect a force Fx in the X-axis direction, a force Fy in the Y-axis direction, and a force Fz in the Z-axis direction. The force sensor device 301 can detect a moment Mx of force rotating around the X axis, a moment My of force rotating around the Y axis, and a moment Mz of force rotating around the Z axis.

### [Schematic Structure of Force Sensor Device]

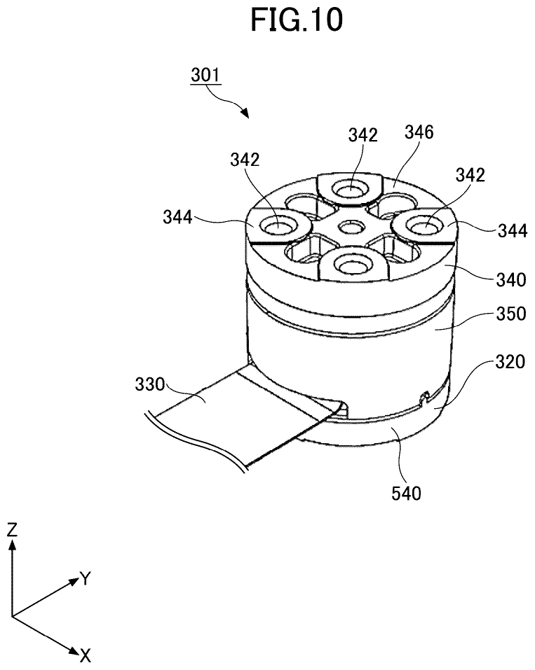

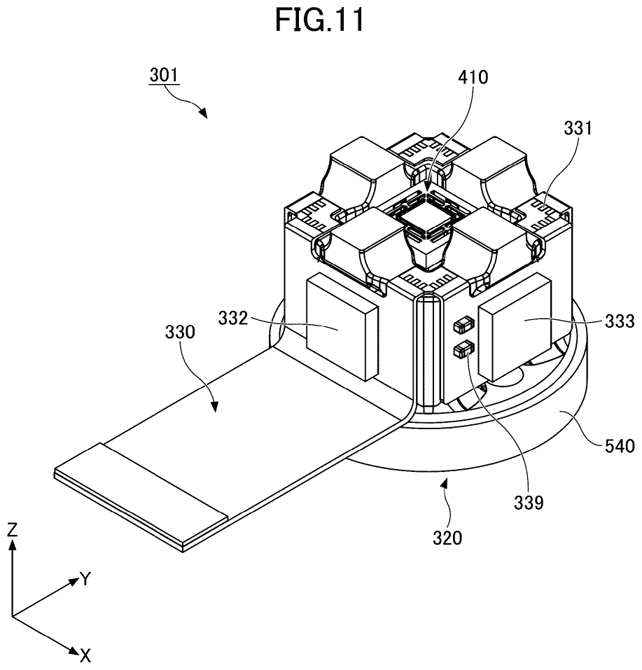

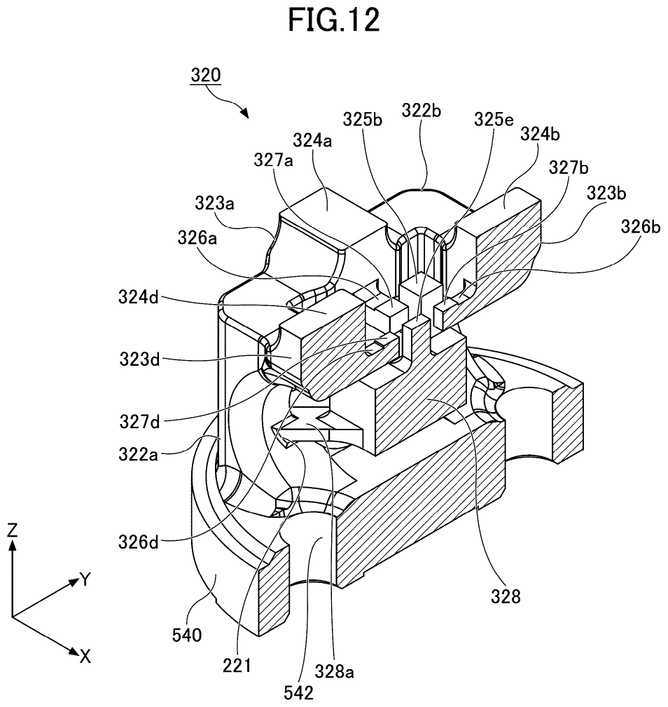

FIG. 10 is a perspective view illustrating an example of the force sensor device of the fourth embodiment. FIG. 11 is a perspective view illustrating a sensor chip, a flexible substrate, and an elastic element.

The force sensor device 301 of the present embodiment illustrated in FIGS. 10 and 11 includes a sensor chip 410, an elastic element 320, a flexible substrate 330, a force-receiving element 340, and a cover 350. The force-receiving element (detector) 340 is arranged to be in contact with the transmission portion 30. The force-receiving element 340 is the detector 50 illustrated in FIGS. 2 and 3. The elastic element 320 includes a connector 540 disposed on the mounting structure 40. For example, the force sensor device 301 is a compact force sensor device. The cover 350 is in a shape of a cylinder. Part of the elastic element 320 and the sensor chip 410 are housed inside the cover 350. The flexible substrate 330 is coupled to the sensor chip 410.

### [Force-Receiving Element]

The force sensor device 301 is arranged to face the transmission portion 30 in the Z-axis direction. The force-receiving element 340 of the force sensor device 301 is coupled to the transmission portion 30. For example, the force-receiving element 340 has a disc shape. A plurality of screw holes 342 are formed in the force-receiving element 340.

On an upper surface of the force-receiving element 340, a plurality of contact surfaces 344 (plane 51 or first plane) to be in contact with the transmission portion 30 are formed. The upper surface of the force-receiving element 340 is arranged in the position that is spaced apart from the cover 350 in the Z-axis direction. Each of the contact surfaces 344 is formed in the periphery of the screw hole 342. The contact surfaces 344 are formed as stepped surfaces that are projected outward of a mounting surface 346 surrounding the contact surfaces 344 in the Z-axis direction. The contact surfaces 344 have predetermined surface roughness. For example, the force-receiving element 340 is formed of stainless steel. For example, the force-receiving element 340 may be fastened to the elastic element 320 by welding.

### [Connector]

The force sensor device 301 is arranged to face the support surface 42a of the mounting structure 40 in the Z-axis direction. The mounting structure 40 is arranged at a side of the force sensor device 301 opposite to the side where the transmission portion is disposed in the Z-axis direction. The connector 540 of the force sensor device 301 is coupled to the mounting structure 40. For example, the connector 540 has a disc shape. As illustrated in FIGS. 2 and 3, screw holes 542 are formed in the connector 540. The connector 540 is fastened to the mounting structure 40 with screws inserted into the screw holes 542.

A plurality of contact surfaces to be in contact with the support surface 42a of the mounting structure 40 are formed on the bottom surface of the connector 540. The bottom surface of the connector 540 is arranged in a position that is spaced apart from the cover 350 in the Z-axis direction. Each of the contact surfaces is formed in the periphery of the screw hole 542.

### [Sensor Chip]

As illustrated in FIG. 11, the sensor chip 410 is mounted on the elastic element 320. The sensor chip 410 is adhered at a top surface side of the elastic element 320 so as not to project from the elastic element 320. The sensor chip 410 is arranged in a position near the force-receiving element 340 in the Z-axis direction.

The sensor chip 410 is a microelectromechanical systems (MEMS) sensor chip that can detect six axial directions of motion per chip, and includes, as a constituent component, a semiconductor substrate, such as a silicon on insulator (SOI) wafer or the like. For example, a planar shape of the sensor chip 110 may be a rectangle having a side of approximately 3,000 μm. A configuration of the sensor chip 410 has been disclosed in the patent application filed by the present inventor (Japanese Unexamined Patent Application Publication No. 2018-185296) and the like, thus the detailed description for the configuration of the sensor chip 410 is omitted.

### [Flexible Substrate]

The flexible substrate 330 inputs signals to the sensor chip 410, and outputs signals from the sensor chip 410. One end of the flexible substrate 330 is coupled to the sensor chip 410, and is disposed inside the cover 350. One end of the flexible substrate 330 is appropriately bent to be disposed along the top surface and side surface of the elastic element 320. Each electrode 331 of the flexible substrate 330 is electrically coupled to the sensor chip 410, for example, by bonding wires.

Active components 332 and 333 are mounted on the flexible substrate 330. The active components 332 and 333 include an IC (AD convertor) configured to convert an analog electrical signal to a digital electrical signal. For example, the active components 332 and 333 are configured to convert analog signals from a bridge circuit that detects forces Fx, Fy, and Fz output from the sensor chip 410 to digital electrical signals. A passive component 339 is disposed on the flexible substrate 330. The passive component 339 includes a resistor and capacitor coupled to the active components 332 and 333.

### [Elastic Element]

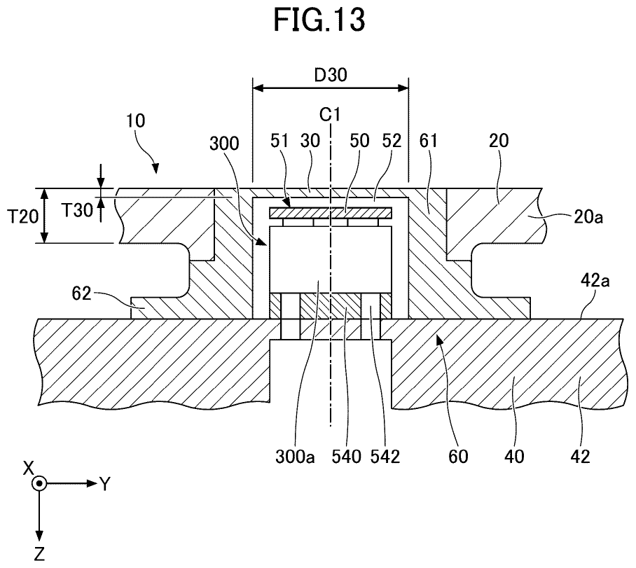

Next, the elastic element 320 will be described with reference to FIG. 12. FIG. 12 is a cross-sectional perspective view illustrating an example of the elastic element of the force sensor device.

The connector 540, which is part of the elastic element 320, is arranged in a position that is spaced apart from the force-receiving element 340 in the Z-axis direction. Within the elastic element 320, a portion above the connector 540 is covered with the cover 350.

The elastic element 320 includes the above-described connector 540, a block 328, a plurality of columns (e.g., 322a etc.), and a plurality of beams 323a, 323b, and 323d. The block 328 is disposed above the connector 540, and functions as a sensor chip mount on which the sensor chip 410 is mounted. The columns 322a are arranged in the periphery of the block 328, and are linked together with the beams 323a, 323b, and 323d.

The columns (e.g., 322a etc.) are arranged evenly (to be point symmetric) with respect to the center of the connector 540 as viewed in the Z-axis direction. The columns (e.g., 322a etc.) are projected from the connector 540, which is a base, in the Z-axis direction. Opposite ends of the columns (e.g., 322a etc.) with respect to the connector 540 in the Z-axis direction are linked together with the beams 323a, 323b, and 323d.

The block 328 is arranged at a center of the columns (e.g., 322a etc.) as viewed in the Z-axis direction. The block 328 has a square shape as viewed in the Z-axis direction. The shape of the block 328 as viewed in the Z-axis direction is not limited to a square, and may be any other polygon or a circle. A thickness of the block 328 is greater than a thickness of the column (e.g., 322a etc.). A length of the block 328 in the Z-axis direction is shorter than a length of the column (e.g., 322a etc.).

The block 328 is arranged in a position that is spaced apart from the connector 540 in the Z-axis direction. As viewed in the Z-axis direction, the block 328 is coupled to the columns (e.g., 322a etc.) via the connection beams 328a that extend in a radial direction of an imaginary circle. Each of the connection beams 328a links a corner of the block 328 and the column 322a or 322b facing the corner as viewed in the Z-axis direction.

Each of the connection beams 328a may be coupled to a lower portion of the column 322a or 322b with respect to a middle point of the column 322a or 322b in the Z-axis direction. A width and thickness of each of the connection beams 328a are smaller than widths and thicknesses of the columns 322a and 322b, and the beam 323a. Therefore, the connection beams 328a are designed to have lower rigidity than rigidity of the columns 322a and 322b and the beams 323a, 323b, and 323d.

Each of the beams 323a, 323b, and 323d includes a portion projecting in an opposite direction with respect to the connector 540 in the Z-axis direction. The beams 323a are projected further in the opposite direction with respect to the connector 540, compared to the columns 322a and 322b. An input mechanism 324a, 324b, or 324d is disposed on a surface of each of the beams 323a that is an opposite side with respect to the connector 540 in the Z-axis direction. Each of the input mechanisms 324a, 324b, and 324d is arranged in the closest position to the force-receiving element 340 in the Z-axis direction, and is arranged in the most distant position from the connector 540 in the Z-axis direction. Each of the input mechanisms 324a, 324b, and 324d is arranged in an intermediate position between the adjacent columns, such as 322a and 322b, as viewed in the Z-axis direction.

The elastic element 320 includes a plurality of beams 326a, 326b, and 326d that extend inward from the beams 323a, 323b, and 323d, respectively, in the radial direction. As viewed in the Z-axis direction, each of the beams 326a, 326b, and 326d extends to a position overlapping the block 328. First contact portions 327a, 327b, and 327d are formed on edges of the beams 323a, 323b, and 323d, respectively. Each of the first contact portions 327a, 327b, and 327d has a contact surface to be in contact with the sensor chip 410. The first contact portions 327a, 327b, and 327d are linked to the input mechanisms 324a, 324b, and 324d via the beams 326a, 326b, and 326d, respectively. Each of the first contact portions 327a, 327b, and 327d is arranged in a position overlapping the block 328 as viewed in the Z-axis direction. The first contact portions 327a, 327b, and 327d are spaced apart from the block 328 in the Z-axis direction. The first contact portions 327a, 327b, and 327d are arranged to face a side of the block 328 opposite to the side at which the connector 540 is disposed in the Z-axis direction.

Moreover, the block 328 includes a plurality of second contact portions 325b and 325e that extend in an opposite direction with respect to the connector 540 in the Z-axis direction. Each of the second contact portions 325b and 325e includes a surface to be in contact with the sensor chip 410. The second contact portion 325e is arranged at a center of the block 328 in the Z-axis direction. The second contact portions 325a, 325b, and 325d are arranged in positions corresponding to the corners of the block 328, respectively, in the Z-axis direction. The first contact portions 327a, 327b, and 327d are arranged between the second contact portions 325b in the X-axis direction and the Y-axis direction.

In the force sensor device 301, as a load is applied to the force-receiving element 340, a relative displacement occurs between the first contact portions 327a, 327b, and 327d and the second contact portions 325b and 325e that are in contact with the sensor chip 410. The sensor chip 410 detects the relative displacement between the first contact portions 327a, 327b, and 327d, and the second contact portions 325a, 325b, and 325e to detect (be able to detect) the force Fx, the force Fy, the force Fz, the moment Mx, the moment My, and the moment Mz. The force sensor device 301 of the present embodiment is known in the related art.

The sensor 300 mounted in the input device 100 is not limited to the above-described force sensor device 301, and force sensor device having a different structure may be used.

Note that, the present disclosure is not limited to the above-described configurations. Other elements may be added to and combined with the configurations of the above-described embodiments to carry out another embodiment. The above-described embodiments may be appropriately changed or modified without departing from the scope and spirit of the present disclosure.

FIG. 13 is a cross-sectional view illustrating an example of a modification example of the sensor and the sensor housing. The above-described embodiments demonstrate the case where the transmission portion 30 is in contact with the detector 50 when force is not input to the tactile portion 20. As illustrated in FIG. 13, the transmission portion 30 may not be in contact with the detector 50 when force is input to the tactile portion 20. As illustrated in FIG. 13, a space 52 is formed between the transmission portion 30 and the detector 50.

In the example illustrated in FIG. 13, as force is applied to the tactile portion 20 by a user, the transmission portion 30 is projected toward the detector 50 so that part of the transmission portion is brought into contact with part of the detector 50. The contact part of the detector 50 functions as the first portion of the detector 50. Therefore, the sensor 300 can detect the force transmitted to the first portion.

Since the transmission portion 30 and the detector 50 are not in contact with each other when force is not input to the tactile portion 20, the transmission portion 30 is not brought into contact with the detector 50 even if a minor force is applied to the tactile portion 20. Specifically, the first portion of the detector 50 is not formed by a minor force, such as vibrations, and such force is not detected by the sensor 300. Therefore, the input device is unlikely to be affected by noise, such as vibrations.

Although the above-described embodiments demonstrate a case where the detector 50 has a plane 51, the detector 50 may have, for example, a curved surface.

### [Input Device of Fifth Embodiment]

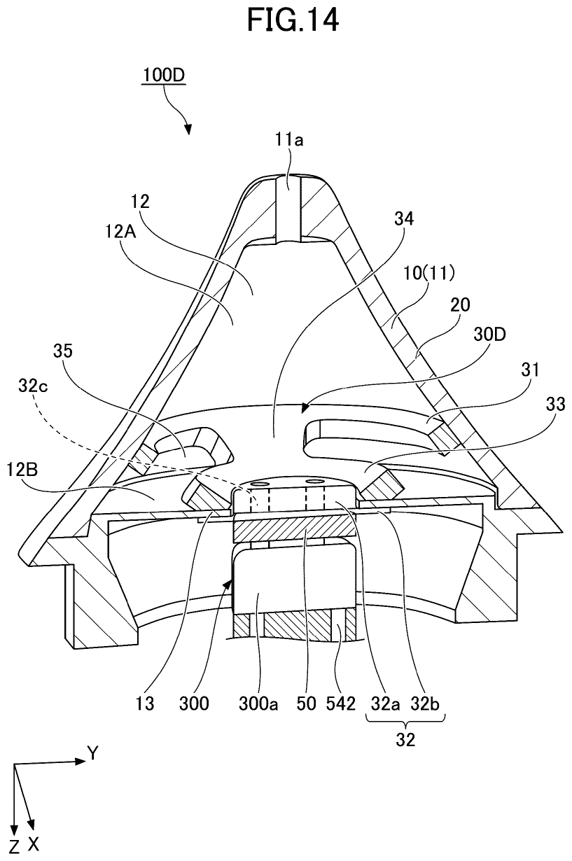

Next, an input device 100D of a fifth embodiment will be described with reference to FIGS. 14 to 17. FIG. 14 is a cross-sectional view illustrating one example of an input mechanism 10 of the input device 100D of the fifth embodiment. The input device 100D of the fifth embodiment illustrated in FIG. 14 is identical to the input device 100 of the first embodiment, except that the input device 100D includes a transmission portion 30D that has a different shape to the shape of the transmission portion 30. In the description of the fifth embodiment, redundant description that may be already mentioned in the first embodiment is omitted.

The input device 100D of the fifth embodiment includes the transmission portion 30D. The transmission portion 30D includes a first portion 31 that is in contact with an inner surface of the tactile portion 20 constituting the container 11. For example, the first portion 31 has a circular shape as viewed in the Z-axis direction. The first portion 31 may have an annular shape. The first portion 31 is extended along a circumferential direction as viewed in the Z-axis direction. The first portion 31 is spaced apart from a bottom surface of the container 11 in the Z-axis direction. The first portion 31 is continuously in contact with the inner surface of the tactile portion 20 along the circumferential direction. A whole circumference of the first portion 31 may be in contact with the inner surface of the tactile portion 20. The bottom surface of the container 11 may be positioned closer to the detector 50 than the first portion 31 is in the Z-axis direction.

Moreover, the transmission portion 30D includes a second portion 32 that is in contact with a top surface of the detector 50. The second portion 32 is fastened to the detector 50, for example, with screws. Through holes 32c, into which the screws are inserted, are formed in the second portion 32. The second portion 32 may not be deformable.

For example, the second portion 32 has a disc shape. A thickness direction of the second portion 32 is the Z-axis direction.

Moreover, the transmission portion 30D includes a third portion that is in contact with the second portion 32. For example, the third portion 33 has an annular shape. The third portion 33 retains the second portion 32. Moreover, the third portion 33 may be in contact with the second portion 32. An opening is formed in the third portion 33, and the second portion 32 is fitted in the opening of the third portion 33. An outer circumferential portion of the second portion 32 is in contact with an inner circumferential surface of the opening of the third portion 33. The transmission portion 30D includes a linking portion 34 that links the first portion 31 and the third portion 33.

The first portion 31 is positioned farther from the bottom surface of the container 11 than the second portion 32 in the Z-axis direction.

Similarly, the first portion 31 is positioned farther from the bottom surface of the container 11 than the third portion in the Z-axis direction. The first portion 31 is disposed above the second portion 32 and the third portion 33.

Specifically, the transmission portion 30D according to the fifth embodiment can input the force applied to the tactile portion 20 to the detector of the sensor 300 via the first portion 31, linking portion 34, third portion 33, and second portion 32 of the transmission portion 30D. Therefore, in addition to the transmission path where the force applied to the tactile portion 20 is used to deform the transmission portion 30D via the fluid inside the container 11 to transmit the force to the detector 50, a transmission path where the force causing the deformation of the tactile portion 20 is transmitted to the detector 50 via the transmission portion 30D is also formed in the input device 100D. Because of the above-described configuration, the input device 100D has improved accuracy in detection of a force input to the tactile portion 20.

For example, an acrylonitrile butadiene styrene (ABS) resin, silicone rubber, an acrylic resin, or the like can be used as a material of the first portion 31, linking portion 34, and third portion of the transmission portion 30D. When a liquid, such as water, is used as the fluid, the material of the first portion 31, linking portion 34, and third portion 33 of the transmission portion 30D is preferably silicone rubber or an acrylic resin, each having excellent water resistance. Moreover, stainless steel, such as SUS304 or the like, may be used as a material of the second portion 32. For example, the stainless steel may be austenitic stainless steel. The rigidity of the transmission portion 30D of the fifth embodiment is preferably higher than the rigidity of the tactile portion 20 for transmitting force applied to the tactile portion to the detector 50. Moreover, the transmission portion 30D of the fifth embodiment may not be deformable.

Moreover, the container 11 includes a bottom surface portion 13. The bottom surface portion 13 may be deformable. The second portion 32 of the transmission portion 30D is arranged in the opening formed in the bottom surface portion 13. The container 11 includes the tactile portion 20, the bottom surface portion 13, and the second portion 32.

The first portion 31 of the transmission portion 30D is arranged to extend over an entire circumference along the inner circumferential surface of the tactile portion 20. The second portion 32 may be a lid covering the opening of the bottom surface portion 13. Specifically, the transmission portion 30D is configured to divide the hollowed-out space 12 inside the container 11 into two, a space 12A and a space 12B. The transmission portion 30D includes a space-communicating portion 35. The space-communicating portion 35 allows the space 12A and the space 12B to communicate. The hollowed-out space 12 is one example of an inner space. The space 12A is one example of a first space. The space 12B is one example of a second space.

Because of the above-described configuration, as force is applied to the tactile portion 20, the fluid inside the space 12A can be moved into the space 12B through the space-communicating portion 35. Since the bottom surface portion 13 is deformable, the fluid inside the space 12A can be moved into the space 12B even when an excessive degree of force is applied to the tactile portion 20. The bottom surface portion 13 functions as a buffering portion owing to the deformable nature of the bottom surface portion 13. Therefore, the force applied to the linking portion 34 is eased, thereby minimizing potential damages of the linking portion 34 that may be caused by the applied force.

The second portion 32 of the transmission portion 30D includes a main body 32a and a projection 32b. For example, the main body 32a has a disc shape. A thickness direction of the main body 32a is the Z-axis direction. The main body 32a is arranged in the opening of the third portion 33. The main body 32a is arranged in the opening of the bottom surface portion 13. The main body 32a is disposed above the detector 50 in the Z-axis direction. The main body 32a is disposed to overlap the detector 50 as viewed in the Z-axis direction.

The projection 32b is projected outward from a side surface of the main body 32a in the radial direction (X-axis direction and Y-axis direction). As viewed in the Z-axis direction, the projection 32b is projected outward from the detector 50 in the radial direction. The projection 32b is arranged to overlap the third portion 33 as viewed in the Z-axis direction. Specifically, the projection 32b and the third portion 33 face each other in the Z-axis direction.

The main body 32a of the second portion 32 and the third portion 33 may not be in contact with each other in the X-axis direction and in the Y-axis direction. Since the projection 32b and the third portion 33 are coupled, the force in the X-axis direction, the force in the Y-axis direction, and the force in the Z-axis direction, which are transmitted from the first portion 31 to the third portion 33, can be transmitted to the second portion 32.

Moreover, the bottom surface portion 13 is interposed between the projection 32b and the third portion 33. The fluid inside the container 11 is shielded with the bottom surface portion 13. Therefore, the bottom surface portion 13 can enhance an effect of enclosing the fluid.

The bottom surface portion 13 has a disc shape. A thickness direction of the bottom surface portion 13 is the Z-axis direction. An opening is formed at a center of the bottom surface portion 13. The bottom surface portion 13 constitutes a bottom portion of the tactile portion 20.

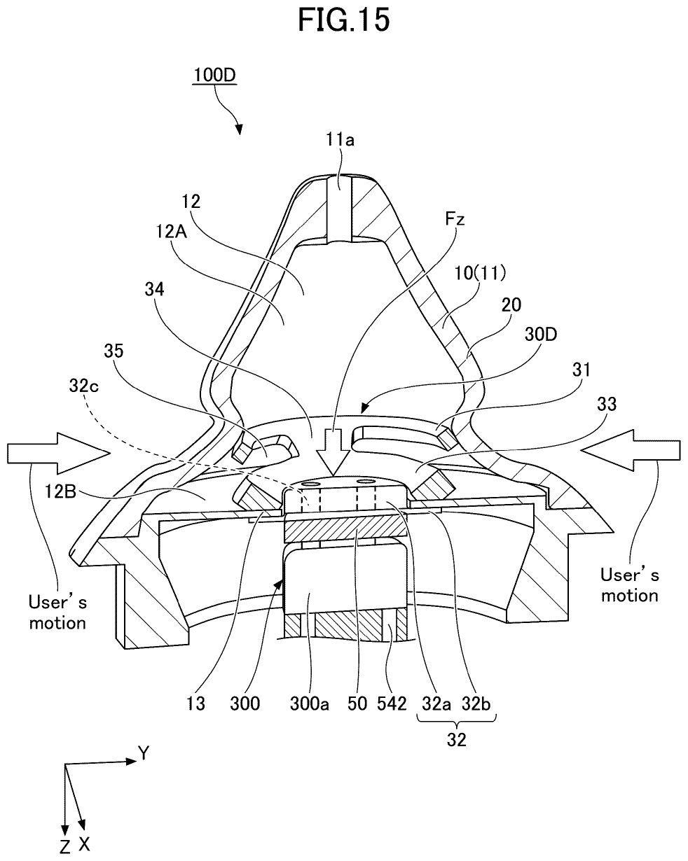

FIG. 15 illustrates an example of the input device 100D when a user pinches the tactile portion 20. In the example illustrated in FIG. 15, as a user pinches the tactile portion 20, the force Fx or Fy is applied to the tactile portion 20 in the X-axis direction or the Y-axis direction. The applied force is transmitted to the first portion 31 of the transmission portion 30D. In FIG. 15, motion of a user to pinch the tactile portion 20 in the Y-axis direction is described as an example. The first portion 31 is deformed to shorten the diameter in the Y-direction, as viewed in the Z-axis direction. The first portion 31 is positioned farther from the bottom surface of the container 11 than the second portion 32 in the Z-axis direction. The degree of deformation of the first portion 31 to shorten the diameter in Y-axis is converted into a force pressing the linking portion 34 in the Z-axis direction. The pressed linking portion 34 presses down the third portion 33 in the Z-axis direction. As described above, the force transmitted to the first portion 31 is converted into a force in the Z-axis direction.

The force transmitted to the third portion 33 is transmitted to the sensor 300 via the second portion 32 so that the sensor 300 detects the force Fz. When a user presses the tactile portion 20, the first portion 31 of the transmission portion 30D is moved down in the Z-axis direction. Along with the movement of the first portion 31, the linking portion 34, the third portion 33, and the second portion 32 are moved down in the Z-axis direction so that the sensor 300 detects the force Fz.

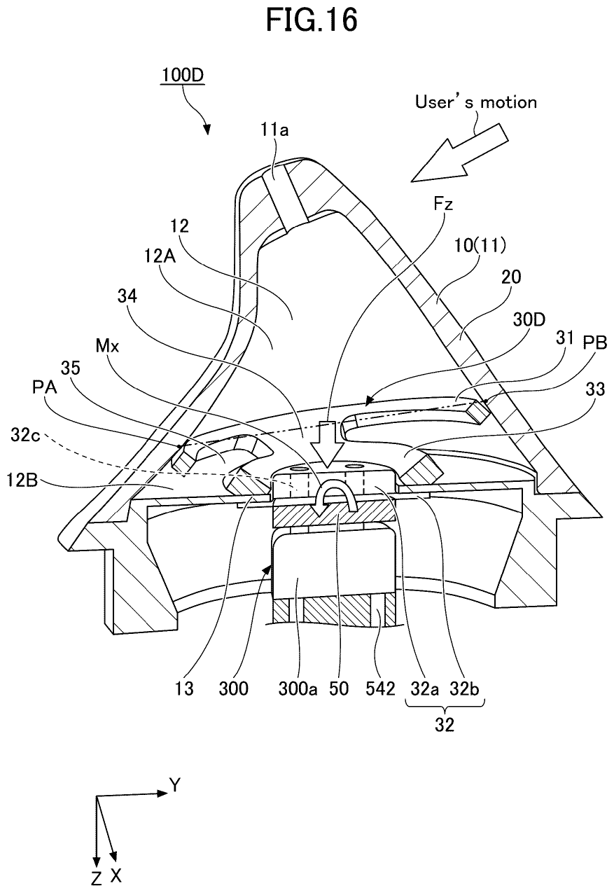

FIG. 16 illustrates an example of a state where the tactile portion 20 is pushed down in the Y-axis direction. In FIG. 16, points PA and PB are depicted. The points PA and PB may be points of positions at which the inner circumferential surface of the tactile portion 20 and the first portion 31 are in contact with each other in the Y-axis direction. The points PA and PB face each other in the Y-axis direction. In the example illustrated in FIG. 16, an imaginary line Li connecting between the point PA and the point PB is inclined with respect to the plane 51 of the sensor 300 in the X-axis direction. The point PA is positioned closer to the bottom surface portion 13 than the point PB is in the Z-axis direction.

In the example where the tactile portion 20 is pushed down in the Y-axis direction, the positions where the tactile portion 20 and the first portion 31 are in contact with each other are not in equilibrium in the Z-axis direction. Specifically, the first portion 31 is inclined with respect to a direction perpendicular to the Z-axis, as viewed in the X-axis direction. In the above-described state, the force transmitted to the sensor 300 is the moment Mx. The moment Mx is a moment of force rotating around the X axis as illustrated in FIG. 4.

In the above-described state, moreover, the point PA moves toward the bottom surface portion 13. Specifically, the first portion 31 of the transmission portion 30D is moved down in the Z-axis direction. Along with the movement of the first portion 31, the linking portion 34, the third portion 33, and the second portion 32 are moved down in the Z-axis direction so that the sensor 300 detects the force Fz. As described above, when a user pushes the tactile portion 20 down in the Y-axis direction, the sensor 300 detects the moment Mx and the force Fz.

Depending on how a user pushes the tactile portion 20 down, the tactile portion 20 may be moved in the Y-axis direction. In the above-described case, the first portion 31 of the transmission portion 30D is moved in the Y-axis direction, the third portion 33 is moved in the Y-axis direction via the linking portion 34, and the second portion 32 linked to the third portion 33 is moved in the Y-axis direction. The force pushing the second portion 32 in the Y-axis direction is transmitted to the sensor 300 so that the sensor 300 detects the force Fy. When a user pushes the tactile portion 20 down in the X-axis direction, the sensor 300 similarly detects the force Fx.

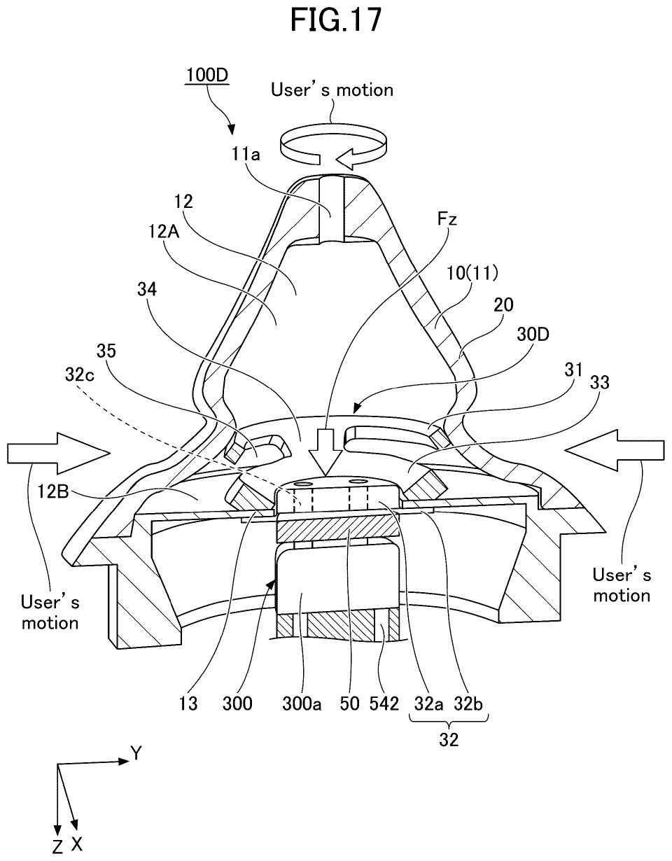

FIG. 17 illustrates an example of directions of force applied when a user pinches the tactile portion 20 to steer the tactile portion 20 in circular motion around the Z axis as a center. For example, the circular motion may be continuous circular motion to turn a plurality of times. During the above-described motion, the direction of the force applied to the tactile portion 20 is continuously changed.

As a user pinches the tactile portion 20, the sensor 300 detects the force Fz. In the pinched state, an upper part of the tactile portion 20 is moved in circular motion around the Z axis as a center. Therefore, a force in the X-axis direction and a force in the Y-axis direction are applied to the upper part of the tactile portion 20. The upper part of the tactile portion 20 is pushed down sequentially in the X-axis direction and in the Y-axis direction. The sensor 300 can detect the state where the upper part of the tactile portion 20 is pushed down in the X-axis direction and the state where the upper part of the tactile portion 20 is pushed down in the Y-axis direction.

In the above-described states, the sensor 300 detects the moment Mx and the moment My. In the above-described states, moreover, the direction of pushing down the upper part of the tactile portion 20 is continuously changed, and thus the forces Fx and Fy, which push the tactile portion 20 in the X-axis direction and the Y-axis direction, respectively, are applied. Therefore, the sensor 300 detects the force Fx and the force Fy.

Next, an example where an operation is performed by pinching an upper part of the tactile portion 20 to twist the tactile portion 20 around the Z axis as a center will be described. As described above, when a user pinches the upper part of the tactile portion 20, the sensor 300 can detect the downward force Fz. The Z axis may be an axis passing through a center of the sensor 300 and extending along the Z-axis direction.

In the pinched state, a user twists the upper part of the tactile portion 20 around the Z axis as a center. Therefore, the first portion 31 coupled to the inner circumferential surface of the tactile portion 20 is moved around the Z axis as a center to turn. In the above-described state, the force transmitted from the tactile portion 20 to the first portion 31 is transmitted to the sensor 300 via the linking portion 34, the third portion 33, and the second portion 32. The sensor 300 can detect the moment Mz in addition to the force Fz.

Table 2 below is a table depicting a relationship between an operation performed on the tactile portion 20 and detection performed by the sensor 300.

TABLE 2

| Operation on tactile portion | Detection by sensor |
|---|---|
| Pinch | Force Fz |
| Press in Z-axis direction | |
| Pinch to push down in Y- | Force Fz, Moment Mx, |
| axis direction | (Force Fy) |
| Pinch to push down in X- | Force Fz, Moment My, |
| axis direction | (Force Fx) |
| Pinch to steer in | Force Fx, Force Fy, Force |
| circular motion around Z | Fz, Moment Mx, Moment |
| axis as a center | My |
| Pinch to twist around Z | Force Fz |
| axis as a center | Moment Mz |

The input device 100D of the fifth embodiment has functions and effects comparable to the above-described input devices 100, 100B, and 100C of the first to fourth embodiments. The sensor 300 can detect force transmitted via the transmission portion 30D. In the input device 100D, force in a plurality of directions applied based on an input operation can be transmitted via deformable members (first portion 31, linking portion 34, and third portion 33).

In the input device 100D, a force applied to the tactile portion 20 in a plurality of direction (force Fx, Fy, and Fz, and moment Mx, My, and Mz) based on an input operation can be transmitted to the second portion 32 via the first portion 31, the linking portion 34, and the third portion 33. In the input device 100D, moreover, both a transmission path where force is transmitted to the second portion 32 via the fluid inside the container 11 and a transmission path where force is transmitted via the first portion 31, the linking portion 34, and the third portion can be used, thereby improving accuracy of the sensor 300 in detection of force.

The sensor 300 includes a detector 50 that is configured to be in contact with the transmission portion 30D. The force applied to the transmission portion 30D is transmitted to the detector 50. The transmission portion 30D includes a first portion 31 that is in contact with an inner surface of the tactile portion 20.

In the input device 100D having the above-described configuration, the force input to the tactile portion 20 is transmitted to the first portion 31. The force transmitted to the first portion 31 is transmitted to the detector 50 of the sensor 300. The sensor 300 can detect the force transmitted to the detector 50.

In the input device 100D, the container 11 includes the bottom surface portion 13. The transmission portion 30D is linked to the first portion 31, and includes a second portion 32 that is in contact with the detector 50. The first portion 31 is positioned farther from the bottom surface portion 13 of the container 11 than the second portion 32.

In the input device 100D having the above-described configuration, the bottom surface portion 13 can constitute a bottom portion of the container 11. The first portion 31 can be positioned farther from the bottom surface portion 13 than the second portion 32. Therefore, the force applied to the first portion 31 is transmitted to the detector 50 via the second portion.

In the input device 100D, the transmission portion 30D includes the third portion 33 that is coupled to the second portion 32. The second portion 32 includes the main body 32a and the projection 32b projecting from the main body 32a to overlap the third portion 33. The bottom surface portion 13 is interposed between the projection 32b of the second portion 32 and the third portion 33.

In the input device 100D of the above-described configuration, the bottom surface portion 13 is interposed between the projection 32b of the second portion 32 and the third portion 33 so that the transmission portion 30D is retained with respect the tactile portion 20.

In the input device 100D, the hollowed-out space (inner space) 12 of the container 11 is divided into the space (first space) 12A and the space (second space) 12B by the transmission portion 30D. The transmission portion 30D includes the space-communicating portion 35 that allows the space 12A and the space 12B to communicate.

According to the above-described configuration of the input device 100D, the fluid in the hollowed-out space 12 of the container 11 can move between the space 12A and the space 12B through a hole that is the space-communicating portion 35. Therefore, the outer shape of the tactile portion 20 can be appropriately changed, and the force can be transmitted to the detector 50 via the fluid.

The present disclosure can provide an input device that can transmit force applied based on an input operation via a fluid. Moreover, the present disclosure can provide an input device capable of transmitting force in a plurality of directions applied based on an input operation via members.

What is claimed is:

1. An input device, comprising:
an input mechanism including a container, the container including a tactile portion and a transmission portion, the tactile portion and the transmission portion being deformable, and the container being capable of encasing a fluid;
a sensor configured to detect a force applied to the transmission portion; and
a mounting structure on which the sensor is disposed.

2. The input device according to claim 1, wherein the sensor includes a detector, the detector is configured to be in contact with the transmission portion, and the force applied to the transmission portion is transmitted to the detector, and wherein
when a force is not input to the tactile portion, the detector is in contact with the transmission portion, and
when a force is input to the tactile portion, the detector includes a first portion that is brought into contact with the transmission portion with a stronger pressure compared to when the force is not input to the tactile portion.

3. The input device according to claim 2, wherein when the force is input to the tactile portion, the transmission portion is pushed out in a direction toward the detector, thereby bringing the transmission portion into closer contact with the detector.

4. The input device according to claim 3, wherein the detector includes a first plane that extends along a first direction and a second direction, where the first direction and the second direction intersect each other, and
the sensor is configured to detect a moment of force rotating around an axis of the first direction or a moment of force rotating around an axis of the second direction, thereby detecting a force at a position outside a center of the first plane.

5. The input device according to claim 2, wherein the detector includes a first plane that extends along a first direction and a second direction, where the first direction and the second direction intersect each other, and wherein
when the tactile portion is operated to change a force continuously applied in the first direction or the second direction in a state in which the force is input by pinching the tactile portion, the first portion is deformed.

6. The input device according to claim 1, further comprising:
a sensor housing that houses the sensor, the sensor housing including a top surface and a cylinder portion, the transmission portion constituting the top surface of the sensor housing, the cylinder portion extending in a direction intersecting the transmission portion, and an opposite end of the cylinder portion from an end of the cylinder portion where the transmission portion is disposed being coupled to the mounting structure,
wherein the sensor is disposed in a space partitioned off by the transmission portion, the cylinder portion, and the mounting structure.

7. The input device according to claim 1,
wherein the transmission portion has a thickness that is smaller than a thickness of the tactile portion, and
deformation of the transmission portion is greater than deformation of the tactile portion.

8. The input device according to claim 1, wherein the transmission portion has rigidity that is lower than rigidity of the tactile portion.

9. An input device comprising:
an input mechanism including a container, the container including a tactile portion and a transmission portion, and the tactile portion and the transmission portion being deformable;
a sensor configured to detect a force applied to the transmission portion; and
a mounting structure on which the sensor is disposed,
wherein the sensor includes a detector that is configured to be in contact with the transmission portion, and the force applied to the transmission portion is transmitted to the detector, and
the transmission portion includes a first portion that is brought into contact with an inner surface of the tactile portion.

10. The input device according to claim 9, wherein the container includes a bottom surface portion,
the transmission portion includes a second portion that is linked to the first portion and is in contact with the detector, and
the first portion is positioned farther from the bottom surface portion of the container than the second portion.

11. The input device according to claim 10, wherein the transmission portion includes a third portion that is coupled to the second portion, the second portion includes a main body and a projection projected from the main body to overlap with the third portion, and
the bottom surface portion is interposed between the projection of the second portion and the third portion.

12. The input device according to claim 9, wherein the transmission portion divides an inner space of the container into a first space and a second space, and
the transmission portion includes a space-communicating portion that allows the first space and the second space to communicate.
